(19) United States
(12) Patent Application Publication
(10) Pub. No.: US 2005/0200204 A1
(43) Pub. Date: Sep. 15, 2005

(54) Security system and a method for the operation thereof

(76) Inventors: Dennis Jonsson, Goteborg (SE); Mattias Malmgren, Kinna (SE); Johan Karlsson, Eldsberga (SE); Johan Sedelius Horberg, Halmstad (SE); Hans-Erik Eldemark, Eldsberga (SE)

Correspondence Address: Arator IP Law Group, PLLC;Suite 1005, 1101 17th Street, NW, Washington, DC, 20036, US

(21) Appl. No.: 11/032,082

(22) Filed: Jan. 11, 2005

(30) Foreign Application Priority Data
Jul. 12, 2002 (SE) 0202194-7
Jul. 3, 2003 (WO) PCT/SE03/01168

(51) Int. Cl. B60R 25/04

(52) U.S. Cl. 307/10.3; 340/5.2

(57) ABSTRACT

A security system for use on a boat with propulsion means, such as an engine, has a base unit mounted on the boat and a personal unit attached to the driver and each passenger. The base unit has a first radio unit and an RFID-reader with an antenna, and is in wireless communication with the personal unit. The personal unit has an RFID-transponder and a second radio unit, both with a unique identity, and a biometric unit that at correct attachment to the person send a biometric signal to the base unit. The communication utilizes RFID technology within a near range, but the system automatically handovers to radio technology when a larger area is to be covered. A field from the RFID reader activates the RFID-transponder, and if the identity is correct the person is registered as the driver and may start the boat. When the base unit loses communication with a personal unit different measures are initiated, such as activating an alarm.

### TECHNICAL FIELD

The present invention relates to a security system for use with a boat having propulsion means, e.g. an engine, such as a vessel, a motorboat, a sailing boat, a ferry, etc., the system comprising a base unit mounted on the boat having a first radio unit, and at least one portable personal unit having a second radio unit with an individual identity, which is in communication with the base unit.

### BACKGROUND OF THE INVENTION

Boating is a popular sport, although there are frequent reports of accidents causing severe damages on human beings as well as on the surroundings. Some of those accidents happen when the driver of the boat falls overboard, while the boat continues at maintained speed, powered by the engine, and rapidly travels further and further away from the spot where the driver falls into the water. There is another scenario if the driver falls overboard in the harbour, where serious damages could be caused to neighbouring boats, other people or to piers and buildings if the engine of the boat is still running. A third scenario may occur if the driver fells overboard into the water and becomes hurt by the boat, e.g. by the propeller.

One type of security means, which mostly is provided in motorboats, consists of a cable, e.g. of a length of 0.50 m to 1.00 m, connected to the current supply of the engine of the boat with one end, and attached to the driver of the boat with the other end. If the driver loses contact with the engine by the cable, the engine will stop immediately. However, a serious drawback with this type of security means is that it impedes the mobility of the driver, for example at anchoring or in situations where the driver has to move around the boat. The consequence is often that the driver ignores to attach the cable to his body, effectively putting the security system out of order, thus being helpless at an incident.

On boats having passengers, there is a further risk of accidents, for example if one or more of the passengers should fall overboard, which could happen in windy or otherwise bad weather.

There are proposed security systems to solve this situation. For example, U.S. Pat. No. 6,150,928 describes an overboard security system comprising multiple, independently powered portable transceivers each with an individual ID code, which are attached to the driver and to the passengers if any, and a base transceiver having multiple displays, the transceiver being in communication with the engine of the boat. The portable transceivers and the base transceiver communicate with each other by radio frequencies, whereby transmitted predetermined data includes the individual ID codes. The base transceiver recognises each of the ID codes and continuously polls data from the portable transceivers and presents the data on the displays. If one of the portable transceivers do not return data to the base transceiver, it will continue to poll the same portable transceiver predetermined number of times to get accurate information, otherwise an alarm will be activated on the display. Since the base transceiver is capable of recognising each ID code, the driver of the boat may be distinguished among the ID codes. If no response from the transceiver of the driver is received, the engine may be halted. The system may be connected to a global positioning system (GPS), which is a well-known system for determining a position.

However, the described previously known system mentioned above has several drawbacks. A severe one is the risk of a non-functional system due to lack of battery power in the portable transceivers; a real fact to face since the system is based on a continuous polling and hence continues data transmitting. The battery power must be checked frequently to avoid this situation.

Another drawback is that the prior art system is not capable of determining when a person on the boat is located outside safe zones. For example, if a person falls into the water at the rear end of the boat, the system does not respond sufficiently fast to avoid that the propeller may hurt the person, since the engine is not stopped until the person is in the water.

Still another drawback is that the prior art system is not capable of determining where on the boat the driver is located and is thus not capable of automatically controlling the speed of the boat in an emergency situation, e. g. to slow down the speed, which may be sufficient to maintain the security in a critical moment. The system is not capable of automatically stopping the engine if the driver falls on the boat and is hurt so that he cannot move to the drivers seat.

Yet another drawback is that the prior art system cannot check if a person on the boat has a portable transceiver attached, i. e. it is not possible to confirm that the system is used and thus protects the persons on board. In addition, there is no adjustment of the time between each poll of a portable transceiver in dependence of the speed of the boat.

Another security system is described in U.S. Pat. No. 4,630,205. The system is particularly adapted for a single person on a small boat for automatically controlling the navigation of the boat. It comprises a radio transmitter attached to the body of the person, a radio receiver installed on the boat to receive a signal transmitted by the radio transmitter, and a control command unit connected to the output of the receiver. The radio transmitter transmits a signal when the person is on board of the boat and stops transmitting the signal or transmits an attenuated signal if the person falls overboard. The control command unit receives a signal from the radio receiver when the signal from the transmitter is stopped or attenuated, and at this moment the movement of the propeller is reversed causing the boat to turn around. This results in a very dangerous situation, if the boat changes direction towards a single person, maybe unconscious, in the water.

In WO 00/00383 a safety device is disclosed which is capable of diverting, slowing down or stopping a boat if the driver falls overboard. The safety device comprises a portable transmitter, a receiver and a unit connected to the automatic piloting system. The portable transmitter is able to transmit electromagnetic waves as a signal having a very limited receiving range equal to the maximum distance that the boat is allowed to travel away from the person in the water before the device intervenes. The receiver picks up the transmitted signal from the portable transmitter and detects when the signal ceases and in this case activates the unit, which is able to slow down the boat, stop it or change course. The safety device is a one way communication system; the person may not exert influence on it. Another drawback is that the system is not adapted for use with several persons.

### SUMMARY OF THE INVENTION

An object of the present invention is to remedy the drawbacks mentioned above and to provide a security system for the safety of an operator and/or passengers of a boat.

A further object of the invention is to provide a security system having personal units attached to each individual on board, so that the system may distinguish between different persons connected to the system.

Another object of the invention is to provide a security system that may ensure that non-authorized persons will not get access to the system.

In order to achieve said objects the invention provides a security system for use with a boat having an engine, the system comprises a base unit including a radio unit and at least one RFID reader having at least one antenna, and a personal unit including an RFID-transponder with a unique identity and a possible biometric unit. The base unit is in wireless communication with the personal unit using RFID technology within a near range, defined by the field of the RFID reader, but will automatically handover to radio technology beyond this range. Those two technologies complement each other; lowest possible power supply is required at the same time as maximal freedom of movement on board the boat is made possible.

The system may be unlocked and activated when the base unit receives a signal from the radio unit or from the RFID-transponder, which is activated by the electromagnetic field from the antenna of the RFID reader. The RF-transponder confirms the activation by sending back an RFID-signal or a radio signal. Since the system may distinguish between different RFID-codes and/or radio codes it may recognize the signal of the driver of the boat, hence giving this identity permission to start the engine of the boat. Everyone else entering the boat may be registered as a passenger having a unique identity. Due to the unique identities of every individual on board and since the system is capable of tracking every individual, proper measure can be initiated at an incident depending on the person involved and where the incident occurs.

In one embodiment of the invention, the base unit of the security system is arranged adjacent to the steering wheel of the boat, or integral with the steering wheel. Both solutions enable an optimal configuration of the antenna for reliable transmission of signals.

Other objects, features and advantages of the present invention will appear from the following detailed description, from the attached drawings as well as from the dependent claims.

### BRIEF DESCRIPTION OF THE DRAWINGS

The invention is described in more detail below, reference being made to the accompanying drawings, in which

FIG. 1 is a schematic block diagram of a security system according to a first embodiment of the invention,

FIG. 2 is a schematic block diagram of a base unit in the system of FIG. 1,

FIG. 3 is a schematic block diagram of a personal unit in the system of FIG. 1,

FIG. 4 is a schematic view illustrating different ranges of the system of FIG. 1 using different technologies,

FIG. 5 is a schematic block diagram of an alternative embodiment of the present invention,

FIG. 6 is a flow chart showing different statuses of the system,

FIG. 7 is a schematic view showing an RFID-antenna in a first configuration,

FIG. 8 is a schematic view showing an RFID-antenna in a second configuration,

FIG. 9 is a front view of a first embodiment of the base unit according to the invention,

FIG. 10 is a side view of the base unit shown in FIG. 9,

FIG. 11 is a front view of a second embodiment of the base unit,

FIG. 12 is an exploded side view of the base unit shown in FIG. 11, and

FIG. 13 is a side view of a third embodiment of the base unit.

### DETAILED DESCRIPTION OF EMBODIMENTS

A security system 100 according to a first embodiment of the invention is designed mainly for use on an open boat where the driver or operator has an overview of the passenger(s), if there is/are any. The boat may be any type of motorboat, day cruiser or sailing boat having an engine.

The system 100 is shown in FIG. 1 and comprises a base unit 101 fixedly mounted on the boat and one or more portable personal unit(s) 102 to be attached to the driver and to the passenger(s). The system 100 further includes a power source 103, mounted on the boat, for example the generator of the engine, and a battery 104, which automatically replaces the current supply from the main power source 103 if it is stopped. The system 100 may be connected to other types of auxiliary equipment 105, such as devices for obtaining data from the surroundings or from the boat, and to some type of navigation system 106. An engine control 107 of the boat is also a part of the system, and is in communication with the base unit 101.

The navigation system 106 may be of any known type, such as GPS (Global Positioning System), GNSS (Global Navigation Satellite System), GNSS-1, etc., to get a position for the boat at an incident, for example a lost signal from a personal unit 102. The base unit 101 will then present the position, time and number of lost personal units 102 on the display 202 after getting the position from the receiver of the navigation system 106, or alternatively the base unit 101 will affect the navigation system to register the position and thereafter send information to an external alarm centre.

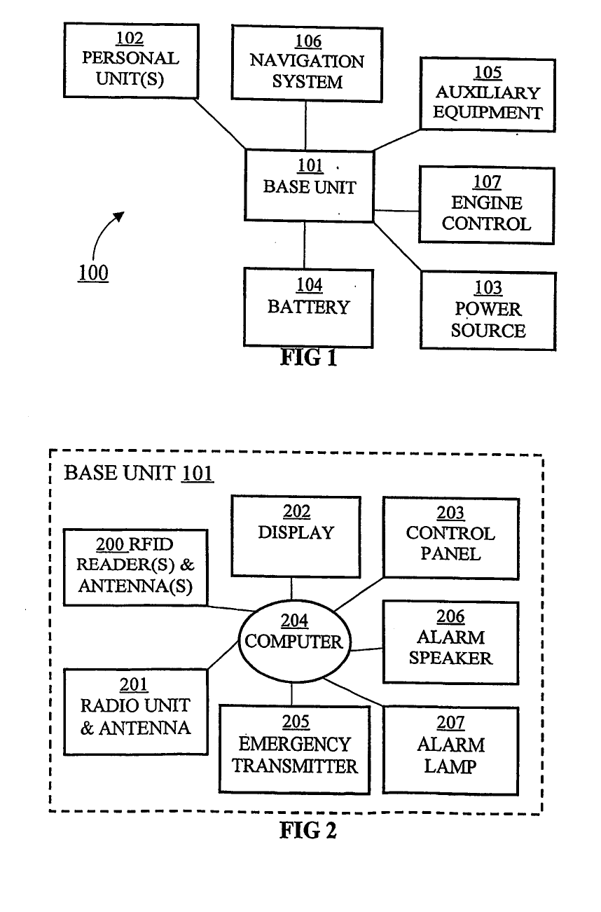

The base unit 101 is shown in more detail in FIG. 2 and comprises an RFID (radio frequency identification) reader or a RFID-transceiver 200 having a decoder and an antenna, a radio unit or radio transceiver 201 with an antenna, a display 202, a control panel 203, a computer 204 having software for signal processing, an emergency transmitter 205, an alarm speaker 206 and an alarm lamp 207. The radio transceiver 201 has either an analogue or a digital protocol depending on the conditions of utility. The emergency transmitter 205, for example an SMS-transmitter or a long wave radio, can send an alarm signal to an external alarm centre, and may include information such as time, position, number of lost personal units 102, biometric data, etc., or the alarm signal can be used to locate the positions of the units 102. This information may also be presented on the display 202 and/or on the display of a mobile telephone 503. The control panel 203 has a keyboard that may be used to input or change different set up conditions or—values of the system, which also is possible to do by the mobile telephone 503.

The base unit 101 is in wireless communication with the existing personal unit(s) 102.

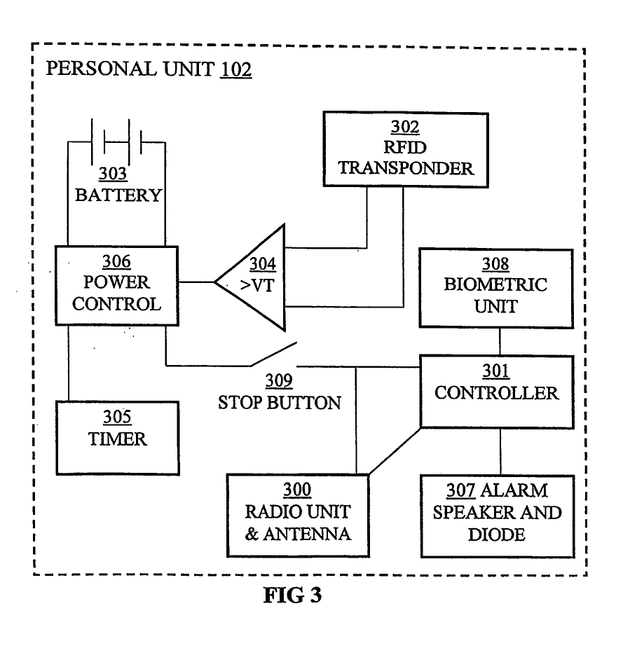

As shown in FIG. 3, each personal unit 102 comprises a radio unit or radio transceiver 300 with an antenna; a controller 301 having a memory and stored software; an RF(radio frequency)-transponder or an RF-tag 302 with a unique identity; a battery 303; a comparator 304; a timer 305; a power control 306; an alarm 307, preferably with a speaker and a diode; a biometric unit or sensor 308; and a stop button 309. The controller 301 is generally known per se and is typically implemented by a microprocessor or another logical device. The transponder 302 is passive and has no battery for power supply; instead the transponder 302 is powered by the magnetic field from a coil of the RFID reader 200 or an antenna, as is well known per se.

The stop button 309 is manually operated by the person wearing the personal unit 102, and is used as a security measure if the person wants to shut off the engine (the driver) or wants to activate an alarm (a passenger), when the person is outside the RFID range. The personal unit 102 will then send a shut off—or an alarm message by radio to the base unit 101, the alarm 206, 207, 307 thus being activated. Accurate acts will be initiated, such as reducing the speed of the engine or immediately stopping the engine.

Another case is a boat not using an engine as propulsion means, such as a sailing boat, having an autopilot. In this case a push at the alarm button will result in a signal affecting the autopilot, for example the boat may then change courses.

The biometric sensor 308 detects a biometric signal from a person wearing the sensor 308, for example heartbeats, pulse or movements. The information is coded in the personal unit 102 and is sent by a radio signal to the base unit 101. The base unit 101 will then act, e.g. send an alarm, retard the speed of the boat or stop the engine, if the information says that the personal unit is not attached or not correctly attached to the person. The main function of the biometric sensor 308 is to confirm that the personal unit 102 is correctly attached to the person. However, the biometric sensor 308 can be used to ensure that the system 100 is activated, by controlling correct attachment of the sensor to the person.

The battery 303 of the personal unit 101 powers the biometric sensor 308. To reduce the current consumption and save the battery 303 the biometric sensor 308 is not activated continuously, but is activated for example every second minute during about 5 seconds by means of the timer 305. Alternatively the timer (not shown) of the base unit 101 will send a request, e. g. every second minute, to the personal unit 102 to check if it is able to detect a signal from the biometric sensor 308. The base unit 101 may also include an emergency transmitter (not shown), for example an SMS-transmitter or a long wave radio, or may affect an external transmitter, e.g. a mobile telephone, which can send an alarm signal. This alarm signal can be sent to an external alarm centre, and may include information such as time, positions, number of lost personal units 102, biometric data, etc., or the alarm signal can be used to locate the positions of the units 102.

The personal unit(s) 102 is wirelessly controlled by external activities or by direct signal input.

The security system 100 is constructed of commercially available standard components.

The inventive security system 100 uses RFID-technology and radio technology to transmit information between the base unit 101 and the personal units 102, wherein the handover is automatically performed and the technology being used in a certain moment is depending on the distance between the base unit 101 and the personal unit(s) 102 due to specific situations, which will be explained in detail below.

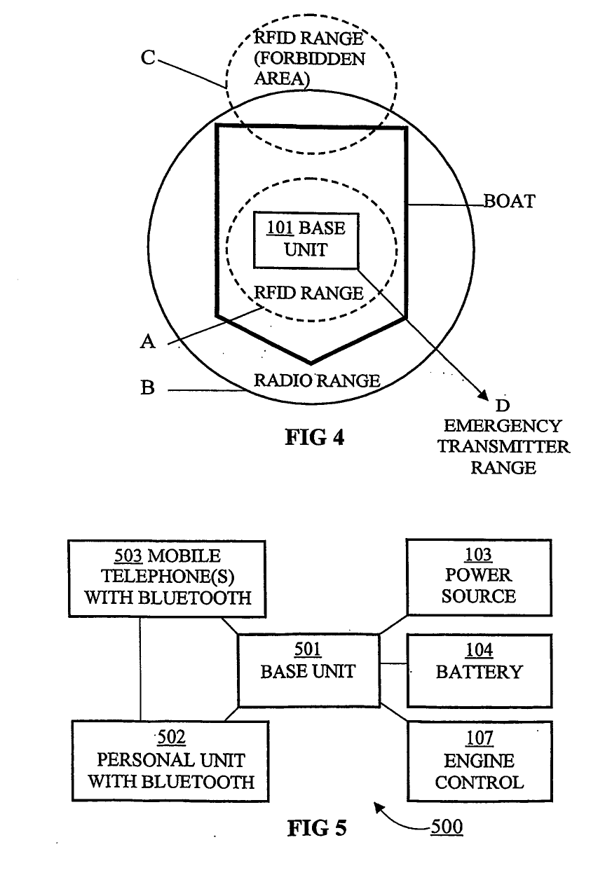

In FIG. 4 a boat provide with a base unit 101 is shown. Around the base unit 101 is a dotted, elliptic line A illustrating a near area or the range for RFID-technology and an unbroken, circular line B illustrating a remote zone or the range for radio-technology. There is another dotted, elliptic line C in the rear of the boat marking a dangerous or forbidden area, which will be explained later. The arrow D illustrates the range for the emergency transmitter 205 of the base unit 101, which in case of emergency may send an alarm to a remote alarm centre. This range D is longer than the radio range B.

An RF-transponder works at a frequency of about 125 kHz and has a range of about 1 m with present technology. The range of the one or more RFID reader 200 defines the near zone, and every RFID reader 200 can be coupled to one or more loop antennas.

A personal unit 102 is normally located within the range A of the RFID reader 200, and the radio unit 300 of the personal unit 102 is then non-active. When the comparator 304 senses a value that is below a set threshold (Vt)—at this moment the signal from RFID-tag is weak, i. e. the personal unit 102 passes the limit of the near range A—it will give a power up signal to the battery 303, see FIG. 3 and 4. The radio unit or transceiver 300 is then activated and starts to communicate with the base unit 101. The radio transmitting is pulsed to save the battery 303, which is performed by the power control 306 and the timer 305. When the personal unit 102 is again within the near range A, the radio communication is shut down and the communication with the base unit 101 switches automatically to be performed by the RFID-tag 302.

The radio-technology may either comprise an analogue or a digital protocol depending on the best solution for a specific situation. As an alternative Bluetooth® transmission may be used. The frequency range varies in different parts of the world, but 430-460 MHz, 902-916 MHz and 2350-2450 MHz are global free for use. Bluetooth is a standard protocol for transmitting information.

A security system 500 using Bluetooth-technology is illustrated in FIG. 5, and comprises a base unit 501 having a WAP-server with a WAP-protocol, which is able to communicate with one or more personal units 502 provided with Bluetooth and with mobile telephones 503 having Bluetooth. This alternative embodiment of the inventive security system 500 comprises also a power source 103 and a battery 104 and is connected to the engine control 107 of the boat, and may also include auxiliary equipment 105 and a navigation system 106 as shown in FIG. 1 though not shown in FIG. 5.

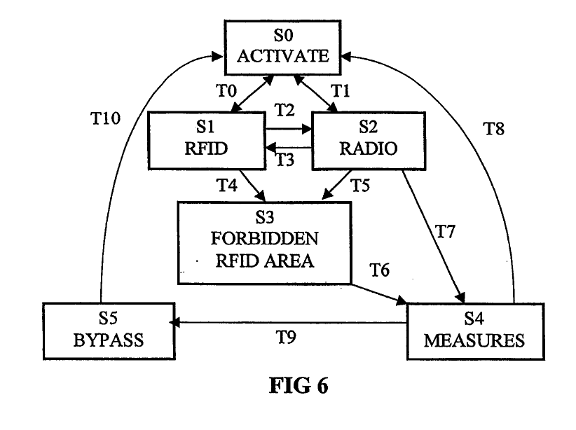

The signal processing disclosing the transmittance of information and data will now be described with reference to FIG. 6. The system 100 has different statuses or positions S0-S5 depending on whether it is activated from OFF-position or has been on for a while working within the RFID range A or radio range B, and whether there has been an incident or accident. The system 100 is automatically activated when the engine of the boat is started, or alternatively, the system 100 must admit allowance to start the engine, position S0. In either of the cases a “key” is needed for unlocking; this is implemented by one of the personal units 101 having a specific identity, a unique RFID-tag. The RFID-tag will be activated by the electro-magnetic field of the RFID reader 200 or from a loop antenna of the base unit 101. The personal unit 102 confirms the activation by sending an RFID-signal back to the base unit 101. The driver of the boat has a certain identity recognized by the base unit 101, the driver being the only person that is permitted to start the engine of the boat. All other personal units 102 will be registered—as described above—as passengers, each having a personal identity by their unique RFID-tag 302 and a unique radio identity. All registered identities may now be seen on the display 202 of the base unit 101. If the driver of the boat has forgotten or lost his personal unit 102, it is possible to enter the system by a predetermined pin code by means of the keyboard of the control panel 203 or by a mobile telephone 503. The person entering the pin code is then recorded as the driver of the boat, identified by his unique RFID code.

Position S1 for the security system 100 is a basic position, wherein both the driver and the passengers are able to move freely within the RFID range A, i. e. a near range according to FIG. 4, and the driver is able to operate the boat normally. Within this range A, the RFID-tag 302 is powered by the magnetic field from the antenna of the RFID reader 200, thus saving battery power for the personal unit 102. The range of one or more RFID readers 200 defines this range A; each RFID reader 200 may be connected to one or more loop antennas. Within the RFID range the system 100 continuously checks the presence of the personal units 102, since the battery 303 is not activated.

Position S2 of the system 100 is featured by communication using radio-technology. The radio range B is enough to cover the entire boat, and preferably an area around the boat. Range B may be any range from 1 m to 1000 m, e. g. up to 10 m or up to 100 m. In this position S2, the base unit 101 and the battery powered personal units 102 communicate with each other by radio technology. The radio communication between the units is disrupted due to a long distance or a denser medium than air, e.g. water. The system registers the positions of the personal units 102 at predetermined time intervals to save the battery 303, when radio technology is used for the signal transmittance, and at an incident, those positions, time of incident and identity of lost personal units 102 will be stored by the base unit 101.

The boat has one or more forbidden areas C defined by the range of one or more additional RFID readers 201 connected to one or more loop antennas. The loop antennas may be located anywhere on the boat, for example in the rear or front end of the boat, and every additional RFID reader is connected to the base unit 101. The system 100 detects when a person enters a forbidden area, position S3, and the base unit 101 will take action; though there is a detectable RFID-signal. For example an alarm could sound in combination with a flashing light, both on the personal unit 102 coupled to the alarm releasing identity and on the base unit 101. The engine of the boat may automatically stop or the speed may be reduced when an alarm is initiated, or if the alarm is initiated when a person enters a forbidden area around another moving device this will be stopped. The display 202 of the base unit 101 will also show the identity of the personal unit 102, which has caused the alarm, so that the driver or other passengers can identify the person in danger.

The system 101 will also act as above, position S4, when the communication with the personal unit 102 is broken; i.e. the signal is lost. Time, position, number of personal units 102 involved and their identity are recorded in the computer 204 for the incident and are also shown on the display 202. In addition, if a mobile telephone 503 is connected to the system 500 the same information will be displayed on the telephone 503.

The system 100 may be manually by-passed, position S5. This should only be done in an emergency situation to make it possible to operate the boat when no signals are detected. The system 100 will warn all persons on board about the by-pass.

Still with reference to FIG. 6, possible signals due to transitions T0-T10 between the different positions S0-S10 will now be discussed. T0: The personal unit 102 is within the RFID range A, the RFID reader 200 of the base unit 101 activates the RFID-tag of the personal unit 102, which confirms by sending back a signal. T1: The base unit 101 automatically sends a signal to the personal unit 102 requesting check of biometric signal. The personal unit 102 verifies by transmitting its radio identity. T0 and T1 are performed simultaneously when the person is within both the RFID range A and the radio range B. T2 and T3: Override between RFID- and radio technology. The communication between the personal unit 101 and the base unit 102 changes from RFID to radio when the distance between those units increases and hence communication by the RFID-tag no longer is possible due to its limited range A. The personal unit 102 detects when the electromagnetic field from the RFID reader 200 fades or disappears and then automatically changes to communicate by radio. The transfer to using radio technology for signal transmittance makes it possible to cover a larger area; however, if the RFID-range is sufficient, the system 101 will automatically switch back to save the battery 306. T4 and T5: The personal unit 102 is within a forbidden area. T6: The base unit 101 detects or is informed that the personal unit 102 is within a forbidden area, which implements an action. T7: The radio signal disappears or is manually switched off, which will initiate an action since the base unit 101 detects no signal. T8: Reactivating the security system 101 after an action has been performed. T9: Manual bypassing the security system 101 after an action. T10: Reactivating the security system 101 after manual bypassing.

Each personal unit 102 has its unique identity code, which is sent with the signal in communication with the base unit 101. The base unit 101 may thus distinguish different personal units 102 and may then ensure that correct signals are received, but may also identify lost signals and then take different steps depending on the identity of the lost signals. The personal unit 102 can—in addition to sending its identity—also send information to the base unit 101 through the signal.

The base unit 101 can be constructed in various embodiments, some of those will now be described. It should be understood that the base unit 101, as described below, comprises components as described above, according to FIG. 2. For the sake of clarity the same reference numerals have been used for the same components in all figures.

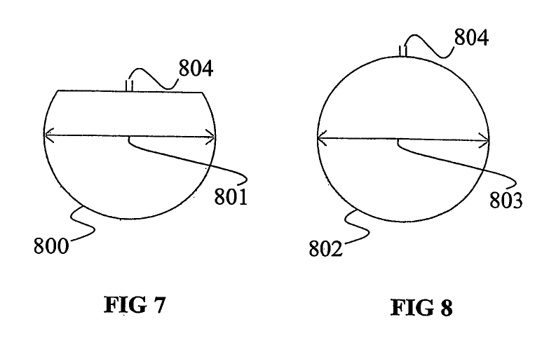

An RFID antenna of the base unit 101 may have different configuration. FIG. 7 shows a partly round antenna 800 having a diameter 801, and FIG. 8 shows a round or circular antenna 802 having a diameter 803. The antennas have means 804 for connection to the radio transceiver 201 having a decoder.

The placement of the antenna is important when using a wireless security system comprising RFID technology. A placement where the personal unit 102 is within the RFID range as much as possible will decrease the battery consumption of the personal unit 102, and the range of the RFID-reader defines the RFID range (A). The base unit 101 may be mounted close to the steering wheel of the boat in order to ensure that the personal unit 102 of the driver is within area A.

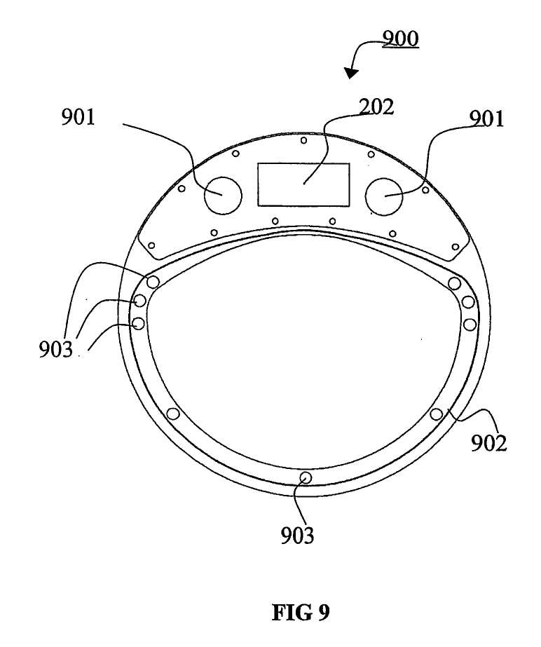

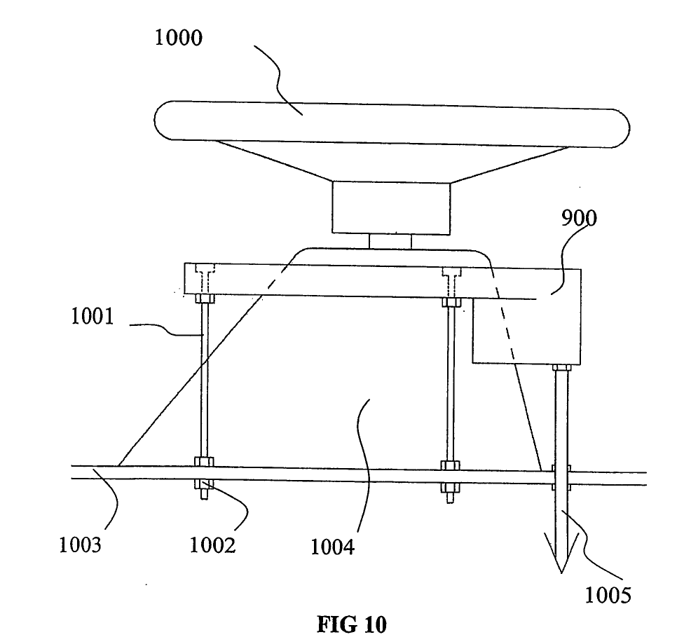

FIG. 9 shows a first embodiment of a base unit 900 that has a configuration adapted to be mounted adjacent and behind the steering wheel 1000 of the boat at the drivers seat. The base unit 900 has a round configuration and comprises a radio unit (not shown), a display 202, control buttons 901, a computer or control means (not shown) and a RFID reader (not shown) having an antenna 902. The antenna 902 has a partly round configuration and is mounted in the periphery of the base unit 900, where also holes 903 are provided for assembling the unit 900 to the boat. FIG. 10 illustrates the base unit 900 according to FIG. 9 as a side view. The base unit 900 is fixed by screws 1001, or other similar fastening means, and nuts 1002 in a partition 1003 of the boat and over a cover 1004 of the steering control of the boat. If this partition 1003 is not suitable for fastening the base unit 900 another attachment of the base unit 900 to the boat may be used. Wires 1005 from the base unit 101, e.g. for power supply, engine stop, GPS, etc., pass through the partition 1003. Those wires 1005 may also pass through a tube that is fixed both in the base unit 101, 900 and the partition 1003 for further stabilization. The distance between the base unit 101, 900 and the steering wheel is about 0.05-0.40 m, preferably 0.07-0.12 m.

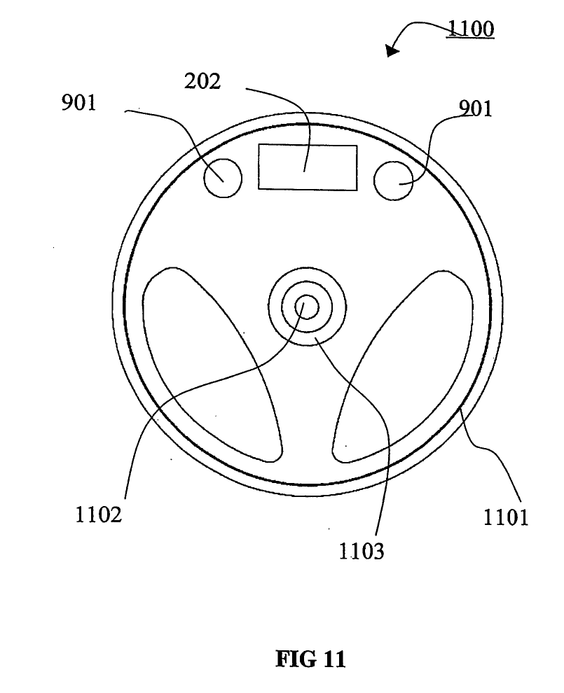

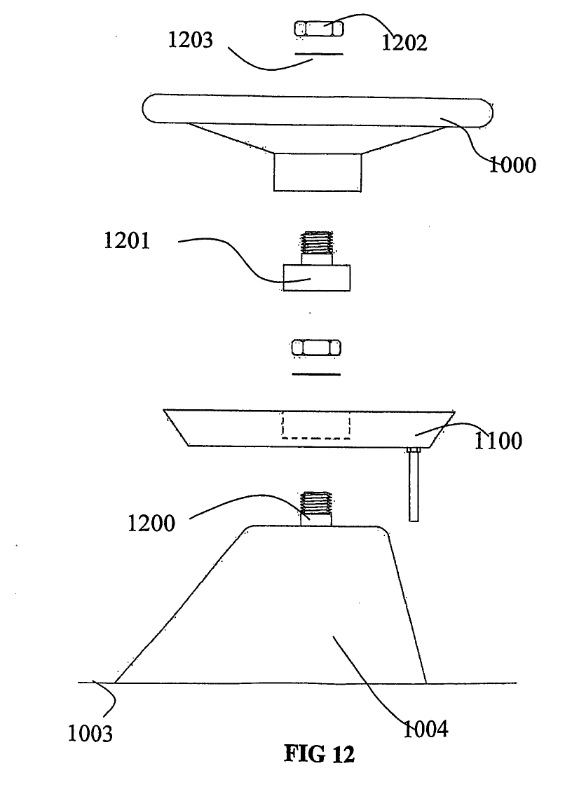

FIG. 11 and FIG. 12 shows a second embodiment of the base unit 1100 having a round or circular configuration. An antenna 1101 may be arranged in the periphery of the base unit 1100, which is mounted on the ordinary axis 1200 of the steering wheel 1000 by means of a wheel axis extension 1201, nuts 1202 and washers 1203. The base unit 1100 has a hole 1102 for the assembly on the steering wheel axis 1200, and is provided with a ball bearing 1103 to make it possible to rotate the steering wheel 1000 without moving the base unit 1100.

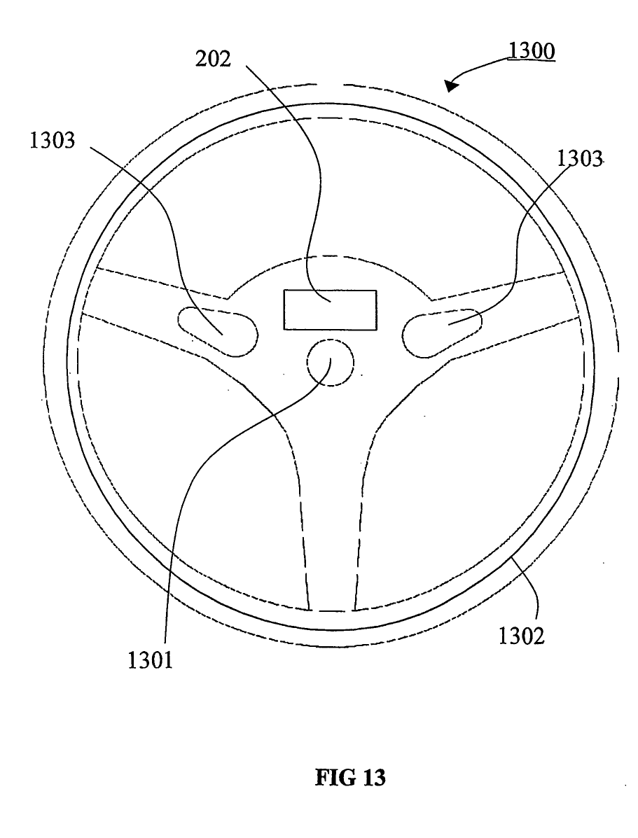

A third embodiment of a base unit 1300, according to FIG. 13, has a construction that is integral with the steering wheel. The construction is mounted on an ordinary steering wheel axis; hence ordinary fastening means 1301 is used. An RFID antenna 1302 is arranged into the periphery of the steering wheel. The construction is provided with a display 202 and buttons 1303.

The base unit 101, 900, 1100, 1300 may have a diameter of e.g. 0.15-0.50 m, preferably 0.18-0.20 m when configured as the first or second embodiment, and preferably 0.30-0.40 when configured according to the third embodiment. The RFID antenna may have merely the same size as the base unit 101, 900, 1100, 1300 when arranged in its periphery.

The above described embodiments have several advantages, e.g. the entire base unit 900, 1100 may be arranged into a box, which will decrease costs for installation and production, respectively; the security system may be installed in a standard way on different types of boats; the base unit 900, 1100 is easy to reach at maintenance; the placement of the display 202 (see FIG. 13) provides a good general view; the RFID antenna 902, 1101 is optimally placed and has a configuration offering a large range A; and the buttons 901, 1303 are easy for the driver to reach.

Another advantage may be to utilise the base unit 101, 900, 1100, 1300 as an antitheft device. This may be embodied by integrating a lock into the base unit 101, 900, 1100, 1300. In addition it is also possible to place an electronic antitheft device into the engine; in this case it is necessary that a personal unit 102 having a predetermined identity unlocks the device to make it possible to start the engine. For example pins moved into predetermined holes for locking the steering wheel may be arranged into the extension axis 1200 or at the fixation site of the base unit 101, 900, 1100, 1300, making it impossible to move the steering wheel 1000 without a pin code or a correct identity code. The locking function will be activated again by a signal having the correct identity and/or by a code from a personal unit 102.

An alternative antitheft device is obtained when pins that normally are in engagement with the steering wheel axis 1200 at operating the boat are brought out of engagement, thus resulting in a spinning steering wheel 1000, the steering function being impossible to affect. In this case the pins will be brought in engagement again by a signal having the correct identity and/or by a code from a personal unit 102.

Still another possibility to construct an antitheft device is to release the extension axis 1201 from the ordinary steering wheel axis 1200, hence allowing the steering wheel 1000 and the extension axis 1201 to move without affecting the ordinary steering wheel axis 1200. The shift on or off may be effected mechanically or electromechanical; in both cases the locking or unlocking, respectively, will be performed by means of a signal having a correct identity and/or a code from the personal unit 102.

The inventive overboard security system 100 offers several advantages in comparison with current systems. By using two technologies, RFID and radio, and making them to mutually cooperate and automatically handover, a safe system 100 with low current consumption (RFID) and great freedom of movement (radio) is obtained. There is no need for power supply when RFID is used, since the transponder 302 is powered by the magnetic field from the antenna of the RFID reader 200, and thus the battery 303 is not drained by the RFID-tag 302. Changing to radio technology for transmitting the signals makes it possible to cover a larger area B. In addition the base unit 101 detects the technology changeover or when a signal is lost, and may then act, e.g. operate the boat differently such as stop the engine or reduce the speed in combination with activating an alarm.

Another advantage of great importance with the use of RFID- and radio technology in combination, is the possibility to detect if the driver is located at the drivers seat based on the fact that the two technologies has different coverage. If the driver is not at the driver's seat but somewhere else on the boat, the system is able to automatically slow down the speed, thereby increasing the safety for the passengers on board.

Another advantage of the inventive system 100 is that the base unit 101 may be adapted to check the contact with the personal unit 102 when the speed of the boat increases, which prevents that the boat has travelled a too long distance before security measures are initiated at an incident or emergency. Contrary, the checking of the personal unit 102 is not so frequent at lower speed of the boat, which saves the battery 303.

Still another advantage is that the system 100 is able to detect if a person has the personal unit 102 correctly attached to the body by the biometric sensor 308, and if not, the system 100 will alarm until the personal unit 102 is correctly positioned and full safety is guaranteed. Each person can further manually activate an alarm 307 in case of emergency, and due to the individual ID codes different measures may be initiated depending on which person has activated the alarm. For example, if the driver of the boat falls overboard the engine of the boat has to be stopped immediately, but if a passenger falls overboard the driver must be able to still operate the boat, perhaps at a lower speed. This increases the safety on board for all passengers, when there are areas within the boat where it is impossible to hear or watch the alarm 206 from the base unit 101.

Yet another advantage is that the system 101 also may include specific dangerous or forbidden areas C identified by one o more specific RFID-readers, which immediately will initiate speed reduction or engine stop when a person enters those areas. This is impossible to obtain with a system only using radio technology.

It should be understood that the described embodiments of the overboard security system 101 are only examples of how it may be embodied, and that there are other possibilities within the scope of the invention for the construction thereof. The security system 101 has been described mainly in the application for open boats of smaller size but it is also applicable on other types of boats. In an alternative embodiment of the security system 101 there could be more than one base unit 101, for example on a larger boat, such as a ferry or a vessel.

When the RFID-technology is further developed, e.g. regarding larger ranges, it should be possible to use several RFID-systems having different ranges instead of using radio technology, when larger areas have to be covered. One possibility is to have a battery in the RFID transponder that enhances the sensitivity and hence the range.

1-29. (canceled)

30. A security system for use in a boat having propulsion means, such as an engine, the system comprising:
a base unit mounted on the boat having a first radio unit;
and one or several portable personal unit having a second radio unit with an individual identity for communication with the base unit, wherein each personal unit comprises an RFID (radio frequency identification) transponder having a unique identity, and the base unit comprises an RFID reader having at least one decoder and at least one antenna, wherein the communication between the base unit and each personal unit is performed by the RFID-transponder and the RFID reader when the distance between the base unit and each personal unit is within a first range (A) and by the radio units outside this first range (A) and within a second range (B) that is defined by the range of the second radio unit, the handover being automatic.

31. A security system according to claim 30, wherein each personal unit comprises a biometric unit:

32. A security system according to claim 30, wherein the system is unlocked and activated when the base unit activates the RFID-transponder of a predetermined personal unit by the electromagnetic field from the antenna of the RFID reader, and activation of the system is confirmed by the predetermined personal unit by sending an RFID-signal to the base unit.

33. A security system according to claim 30, wherein the engine of the boat is allowed to be started when a predetermined RFID identity has been registered, this RFID identity being recorded as the driver of the boat.

34. A security system according to claim 30, wherein the engine of the boat may be started by entering a predetermined pin code by means of a control panel of the base unit or by a mobile telephone, the RFID identity of the person entering the pin code being predetermined as the driver of the boat.

35. A security system according to claim 30, wherein the system comprises one or more additional personal unit/units.

36. A security system according to claim 35, wherein the additional personal unit is registered as a passenger, when the personal unit is sending back either an RFID signal or a radio signal to the base unit.

37. A security system according to claim 36, wherein an alarm is activated when the base unit does not receive signals from one of the personal units, and a measure will be initiated.

38. A security system according to claim 33, wherein unlocking and activation of the system is allowed only when a biometric signal is received from a personal unit with an RFID-transponder having a predetermined identity.

39. A security system according to claim 30, wherein the radio communication may comprise an analogue or a digital protocol.

40. A security system according to claim 30, wherein the system comprises one or several second RFID readers with a third range (C), wherein the third range (C) defines a forbidden area and when a person enters the third range (C) an alarm of the personal unit is activated.

41. A security system according to claim 40, wherein the current supply of the engine of the boat is terminated when a person enters the forbidden area.

42. A security system according to claim 30, wherein the base unit further comprises a display, which continuously presents the presence of the personal units.

43. A security system according to claim 30, wherein the base unit registers the presence of each personal unit at predetermined time intervals when the signal transmittance is performed by radio technology, and stores position, time and lost personal units at an incident.

44. A security system according to claim 43, wherein the time intervals for registration and storing decrease when the speed of the boat increases.

45. A security system according to claim 30, wherein the base unit is arranged to send instructions to each personal unit when the alarm is activated or when the biometric unit is checked.

46. A security system according to claim 30, wherein the system is in communication with a position navigation system, the position of the boat being recorded when an alarm is activated.

47. A security system according to claim 30, wherein the system comprises an emergency transmitter.

48. A security system according to claim 30, wherein the at least one personal unit comprises a stop button for manually switching off the radio unit, and hence activating an alarm.

49. A method for operating a security system, comprising the steps of:
activating an RFID-transponder of the at least one personal unit by an electromagnetic field of a RFID reader of a base unit, said RFID reader defining permitted and/or forbidden areas by the range of said RFID reader;
verifying the activation by sending an RFID signal from the activated RFID-transponder;
establishing a wireless communication between the base unit and the at least one personal unit using RFID-technology within a set range (A) and by using radio-technology outside this range (A), the handover being automatic;
activating an alarm when one of the at least one personal units leaves the permitted areas, enters forbidden areas, or when no signal is detected by the base unit; and
performing a security measure.

50. A base unit for a wireless security system, which is arranged on a boat having propulsion means, such as an engine, comprises:
a steering-wheel for steering control of the boat;
a radio unit and a receiver having a decoder;
at least one antenna, which has a circular or partly circular configuration, wherein the base unit is arranged adjacent to the steering wheel.

51. A base unit according to claim 50, wherein the base unit further comprises a display and a control panel.

52. A base unit according to claim 50, wherein the base unit is fixed to a cover of the steering control in close vicinity of steering-wheel.

53. A base unit according to claim 50, the base unit is arranged on an extension axis for extension of a central axis of the steering-wheel, the extension axis being fixed to a cover of the steering control.

54. A base unit according to claim 53, wherein a ball bearing is provided allowing the steering-wheel to rotate without rotating the base unit.

55. A base unit according to claim 50, wherein the steering wheel comprises said base unit.

56. A base unit according to claim 55, wherein the at least one antenna is arranged in the periphery of the steering wheel.

57. A base unit according to claim 50, further comprising:
a locking arrangement comprising a pin and a mating opening in said steering wheel, so that when the pin is placed in said opening the steering wheel is locked in position; and
a pin release arrangement for withdrawing said pin from said opening upon receipt of an unlocking signal from said base unit when a personal unit with a predetermined identity is present within said first range A.
